(19) United States
(12) Patent Application Publication
(10) Pub. No.: US 2017/0059058 A1
(43) Pub. Date: Mar. 2, 2017

(54) Needle Valve and Associated Methods

(71) Applicant: Precision High Pressure, LLC, College Station, TX (US)

(72) Inventors: Kent Richard Hemme, Fairview, PA (US); Jeffrey Paul Shuman, College Station, TX (US)

(21) Appl. No.: 15/200,664

(22) Filed: Jul. 1, 2016

Related U.S. Application Data
(60) Provisional application No. 62/283,333, filed on Aug. 28, 2015.

(51) Int. Cl. F16K 31/50; F16K 1/12

(52) U.S. Cl. CPC F16K 31/506; F16K 1/12

(57) ABSTRACT

Exemplary embodiments are directed to a needle valve that generally includes a valve seat, a first stem in threaded engagement with a first stem thread, and a second stem in threaded engagement with a second stem thread. Rotation of the first stem advances the first stem and the second stem towards the valve seat by a distance that is equal to a combined thread pitch of the first stem thread and the second stem thread. Engagement of the first and second stems during rotation of the first stem defines a dual thread actuation mechanism.

### CROSS-REFERENCE TO RELATED APPLICATIONS

The present application claims the benefit of priority of U.S. provisional patent application entitled “Quick Open Manual Needle Valve,” which was filed on Aug. 28, 2015, and assigned Ser. No. 62/283,333. The entire content of the foregoing provisional application is incorporated herein by reference.

### TECHNICAL FIELD

The present disclosure relates to a needle valve and associated methods and, in particular, to a needle valve including a dual set of threads working in opposition such that the valve stem travels a distance equal to the combined thread pitches, resulting in a faster opening or closing of the needle valve.

### BACKGROUND

A needle valve is generally used to control flow by varying the distance between a stem tip and a valve seat. Manual needle valves can be operated by turning a handle that is connected to a stem. The stem generally includes screw threads that cooperate with complementary threads inside the body of the needle valve (e.g., a single set of threads), and rotation of the handle is converted into linear motion by interaction of the screw threads.

Depending on the direction of rotation of the handle and the direction of the screw threads, rotating the handle results in movement of the stem up or down relative to a valve seat. One full turn of the handle generally results in the stem traveling a distance of one thread pitch. Traditional needle valves may take five or more full turns of the handle to completely open (e.g., expose a maximum orifice area) or completely close (e.g., close the orifice area) the needle valve.

When a needle valve is under pressure, the force required to turn the handle to open or close the needle valve can be significant. As a result, some operators choose to only partially open the needle valve. Partially opening the needle valve continuously can lead to premature failure of the valve seat over time. In addition, the needle valve capacity is limited when operating at an only partially open position.

### SUMMARY

In accordance with embodiments of the present disclosure, an exemplary needle valve is provided that includes a dual set of threads working in opposition such that the valve stem travels a distance equal to the combined thread pitches, resulting in faster opening or closing of the needle valve. In particular, the exemplary needle valve generally requires half (or less) of the number of handle rotations to achieve the full travel for opening or closing the valve as compared to traditional needle valves with a single set of threads depending on the combination of thread pitches used. Although discussed herein with respect to a needle valve that is manually actuated, it should be understood that a substantially similar thread structure can be used in a needle valve configured to be actuated in an automated manner.

In accordance with embodiments of the present disclosure, an exemplary needle valve is provided that generally includes a valve body, a needle assembly, and a packing gland assembly. The valve body includes a first port, a second port, and a passage formed in a valve seat fluidically connecting the first and second ports. The needle assembly can be at least partially disposed within the valve body. The needle assembly generally includes a proximal end and a distal end. The distal end of the needle assembly can be configured to mate with the valve seat to selectively close the passage.

The needle assembly generally includes an upper stem (e.g., a first stem) including an upper stem bore formed therein. The upper stem includes a first set of external threads on an outer surface of the upper stem and a first set of internal threads within the upper stem bore. The needle assembly generally includes a mid-stem (e.g., a second stem) including a second set of external threads on an outer surface of the mid-stem. The second set of external threads can be complementary to the first set of internal threads of the upper stem.

The packing gland assembly can be disposed around at least a portion of the needle assembly. The packing gland assembly generally includes a packing gland body with a second set of internal threads formed within a packing gland body bore. The second set of internal threads can be complementary to the first set of external threads of the upper stem. In response to actuation of the needle assembly to close the passage in the valve seat, the first set of external threads of the upper stem interact with the second set of internal threads of the packing gland body to move the upper stem in the direction of the valve seat. Further, in response to actuation of the needle assembly to close the passage in the valve seat (e.g., due to rotation of the upper stem), the first set of internal threads of the upper stem interact with the second set of external threads of the mid-stem to move the mid-stem in the direction of the valve seat.

A distance traveled by the upper stem along a central longitudinal axis of the needle assembly corresponds to a thread pitch of the first set of external threads of the upper stem. A distance traveled by the mid-stem along the central longitudinal axis of the needle assembly corresponds to a combination of the thread pitch of the first set of external threads of the upper stem and the second set of external threads of the mid-stem (e.g., a dual thread actuation mechanism). Interaction of the first set of external threads of the upper stem with the second set of internal threads of the packing gland body, and interaction of the first set of internal threads of the upper stem with the second set of external threads of the mid-stem forms a dual thread set actuation mechanism. In some embodiments, interaction of the first set of external threads of the upper stem with the second set of internal threads of the packing gland body is simultaneous (or substantially simultaneous) to interaction of the first set of internal threads of the upper stem with the second set of external threads of the mid-stem.

A proximal end of the mid-stem can include the second set of external threads, and a distal end of the mid-stem can include a mid-stem opening formed therein. In some embodiments, the mid-stem opening can include a first portion defining a first diameter and a second portion defining a second diameter, the first diameter being dimensioned smaller than the second diameter. The needle assembly includes a lower stem (e.g., a third stem) interlocked with the mid-stem opening at the distal end of the mid-stem. The lower stem includes a proximal end and a distal end. The distal end of the lower stem can form a stem seat configured and dimensioned to mate with the valve seat to close the passage. In some embodiments, the proximal end of the lower stem can include a first portion defining a first diameter and a second portion defining a second diameter, the first diameter being dimensioned smaller than the second diameter. The configuration of the distal end of the mid-stem and the proximal end of the lower stem allows for interlocking of the mid-stem relative to the lower stem. In some embodiments, an alternative mechanism can be used to secure the lower stem to the mid-stem.

In response to actuation of the needle assembly, the upper stem rotates relative to the valve body, the mid-stem moves within the valve body without rotating, and the lower stem moves within the valve body with the mid-stem without rotating. In particular, the packing gland body bore is keyed to the mid-stem to prevent rotation of the mid-stem within the valve body in response to actuation of the needle assembly. Thus, the upper stem is configured to rotate and move in an upward or downward direction relative to the valve seat along a central longitudinal axis. Rotation and movement of the upper stem results in movement of the mid-stem in an upward or downward direction relative to the valve seat along the central longitudinal axis without rotating. Movement of the mid-stem results in movement of the lower stem in an upward or downward direction relative to the valve seat along the central longitudinal axis without rotating.

In some embodiments, a handle can be secured to the proximal end of the needle assembly and configured to rotatably actuate the needle assembly to open or close the needle valve. In some embodiments, the needle assembly can be actuated in an automated manner. The packing gland body includes a third set of external threads on an outer surface of the packing gland body. The third set of external threads can be complementary to a third set of internal threads within a bore of the valve body. In some embodiments, the packing gland assembly includes a top packing washer, one or more packing rings (e.g., two packing rings), and a bottom packing washer disposed around a portion of the lower stem of the needle assembly. The top packing washer, the packing rings and the bottom packing washer maintain a fluid tight seal between the needle assembly, the valve body, and the passage in the valve seat.

In accordance with embodiments of the present disclosure, an exemplary needle valve is provided that generally includes a valve body, a needle assembly, and a packing gland assembly. The valve body can include a passage in a valve seat. The needle assembly can be at least partially disposed within the valve body. The needle assembly can include an upper stem including an upper stem bore formed therein. The upper stem can include a first set of external threads on an outer surface of the upper stem and a first set of internal threads within the upper stem bore. The needle assembly can include a mid-stem including a second set of external threads on an outer surface of the mid-stem.

The packing gland assembly can include a packing gland body with a second set of internal threads within a packing gland body bore. In response to actuation of the needle assembly to close the passage in the valve seat, the first set of external threads of the upper stem interact with the second set of internal threads of the packing gland body to move the upper stem in the direction of the valve seat. In addition, in response to actuation of the needle assembly to close the passage in the valve seat (e.g., due to rotation of the upper stem), the first set of internal threads of the upper stem interact with the second set of external threads of the mid-stem to move the mid-stem in the direction of the valve seat. In some embodiments, interaction of the first set of external threads with the second set of internal threads can be simultaneous (or substantially simultaneous) to actuation of the first set of internal threads with the second set of external threads.

Interaction of the first set of external threads of the upper stem with the second set of internal threads of the packing gland body, and interaction of the first set of internal threads of the upper stem with the second set of external threads of the mid-stem forms a dual thread set actuation mechanism. The needle assembly can include a lower stem interlocked with a mid-stem opening at a distal end of the mid-stem. A distal end of the lower stem can form a stem seat. In response to actuation of the needle assembly, the upper stem rotates relative to the valve body, the mid-stem moves within the valve body without rotating (e.g., due to the keyed configuration of the packing gland body bore and an outer surface of the mid-stem), and the lower stem moves within the valve body with the mid-stem without rotating.

In accordance with embodiments of the present disclosure, an exemplary method of operating a needle valve is provided. The method includes providing a needle valve having the structure described herein. The method includes actuating the needle assembly to close the passage in the valve seat (e.g., by actuating rotation of the upper stem of the needle assembly). In response to actuation of the needle assembly to close the passage in the valve seat, the first set of external threads of the upper stem interact with the second set of internal threads of the packing gland body to move the upper stem in the direction of the valve seat, and the first set of internal threads of the upper stem interact with the second set of external threads of the mid-stem to move the mid-stem in the direction of the valve seat.

In some embodiments, interaction of the first set of external threads with the second set of internal threads can be simultaneous (or substantially simultaneous) to interaction of the first set of internal threads with the second set of external threads. Although discussed herein with respect to closing of the needle valve, it should be understood that actuation of the needle assembly in an opposing direction (e.g., rotation of the upper stem in an opposing direction) results in interaction of the first set of external threads with the second set of internal threads and interaction of the first set of internal threads with the second set of external threads in an opposing direction moves the upper stem and the mid-stem away from the valve seat to regulate the degree of opening of the needle valve. The needle assembly can include a lower stem interlocked with the mid-stem. A distal end of the lower stem can form a stem seat. In response to actuation of the needle assembly to close the passage in the valve seat, the lower stem moves in the direction of the valve seat with the mid-stem to position the stem seat against the valve seat, thereby closing the passage and the needle valve.

In accordance with embodiments of the present disclosure, an exemplary needle valve is provided. The needle valve generally includes a valve seat, a first stem in threaded engagement with a first stem thread (e.g., an upper stem), and a second stem (e.g., a mid-stem) in threaded engagement with a second stem thread. In some embodiments, rotation of the first stem advances the first stem and the second stem towards the valve seat by a distance that is equal to a combined thread pitch of the first stem thread and the second stem thread. In some embodiments, rotation of the first stem can advance the first stem towards the valve seat by a first distance and can advance the second stem towards the valve seat by a second distance that is greater than the first distance (e.g., a larger pitch of the second stem). In some embodiments, rotation of the first stem can advance the first stem towards the valve seat by a first distance and can advance the second stem towards the valve seat by a second distance that is substantially equal to the first distance (e.g., an equal pitch of the first and second stems).

The first stem thread can include a first set of external threads on an outer surface of the first stem, and the second stem thread can include a first set of internal threads within a first stem bore of the first stem. The second stem can include a second set of external threads in threaded engagement with the first set of internal threads of the first stem. The needle valve can include a packing gland body including a second set of internal threads. The first set of external threads of the first stem can be in threaded engagement with the second set of internal threads of the packing gland body. The first distance advanced by the first stem towards the valve seat can correspond to a thread pitch of the first set of external threads of the first stem, and the second distance advanced by the second stem towards the valve seat can correspond to a combination of the thread pitch of the first set of external threads of the first stem and a thread pitch of the second set of external threads of the second stem (e.g., a dual thread actuation mechanism).

Engagement of the first set of external threads of the first stem with the second set of internal threads of the packing gland body can be simultaneous (or substantially simultaneous) to interaction of the first set of internal threads of the first stem with the second set of external threads of the second stem. A distal end of the second stem can include a second stem opening formed therein. The second stem opening can include a first portion defining a first diameter and a second portion defining a second diameter. The first diameter can be dimensioned smaller than the second diameter.

The needle valve can include a third stem (e.g., a lower stem) interlocked with the second stem opening at the distal end of the second stem. The third stem can include a proximal end and a distal end. The distal end of the third stem can form a stem seat. The proximal end of the third stem can include a first portion defining a first diameter and a second portion defining a second diameter. The first diameter can be dimensioned smaller than the second diameter.

The first stem can rotate relative to the valve seat. The packing gland body can be keyed to the second stem to prevent rotation of the second stem relative to the valve seat during rotation of the first stem. During rotation of the first stem, the third stem can move relative to the valve seat with the second stem along the central longitudinal axis without rotating. The needle valve can include a handle secured to a proximal end of the first stem. The handle can be configured to actuate rotation of the first stem to open or close the needle valve. The needle valve can include a top packing washer, one or more packing rings, and a bottom packing washer disposed within the packing gland body.

In accordance with embodiments of the present disclosure, an exemplary method of operating a needle valve is provided. The method includes providing a needle valve including a valve seat, a first stem in threaded engagement with a first stem thread, and a second stem in threaded engagement with a second stem thread. The method includes actuating rotation of the first stem to close the needle valve. In some embodiments, rotation of the first stem advances the first stem and the second stem towards the valve seat by a distance that is equal to a combined thread pitch of the first stem thread and the second stem thread. In some embodiments, rotation of the first stem can advance the first stem towards the valve seat by a first distance and can advance the second stem towards the valve seat by a second distance that is greater than the first distance (e.g., a larger pitch of the second stem). In some embodiments, rotation of the first stem can advance the first stem towards the valve seat by a first distance and can advance the second stem towards the valve seat by a second distance that is substantially equal to the first distance (e.g., an equal pitch of the first and second stems).

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed needle valves and associated methods, reference is made to the accompanying figures, wherein:

FIG. 1 is a perspective ⁻view of an exemplary needle valve according to the present disclosure.

FIG. 2 is a cross-sectional view of the exemplary needle valve of FIG. 1 taken along section line 2-2.

FIG. 3 is a cross-sectional view of a mid-stem to packing gland interface of the exemplary needle valve of FIG. 1 taken along section line 3-3.

FIG. 4 is a cross-sectional view of an upper stem, mid-stem and lower stem of the exemplary needle valve of FIG. 1 taken along section line 2-2.

### DESCRIPTION OF EXEMPLARY EMBODIMENTS

It should be understood that the relative terminology used herein, such as “upper”, “mid”, and “lower” is solely for the purposes of clarity and designation and is not intended to limit the invention to embodiments having a particular position and/or orientation. Accordingly, such relative terminology should not be construed to limit the scope of the present invention.

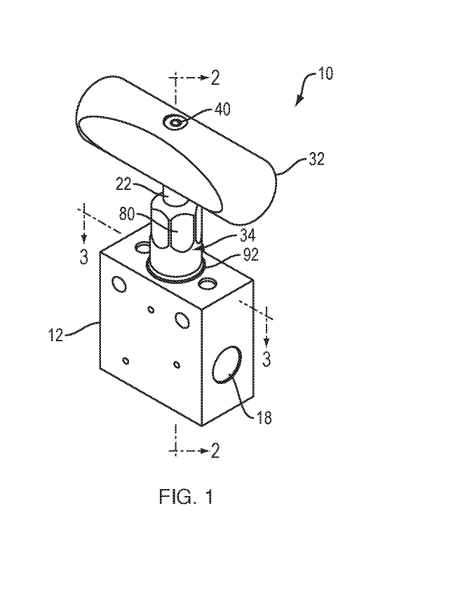

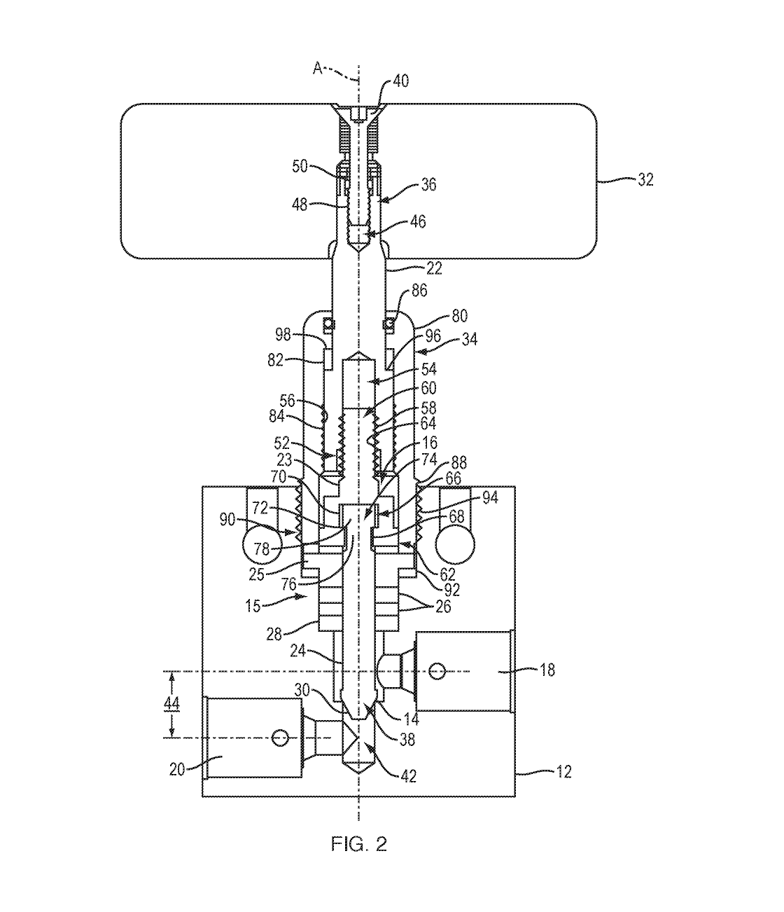

FIGS. 1-4 show perspective, cross-sectional and detailed views of an exemplary needle valve 10. Referring to FIGS. 1-4, the needle valve 10 can include a valve body 12 configured to house a valve seat 14 and a needle assembly 16. The needle assembly 16 includes an upper stem 22 (e.g., a first stem), a mid-stem 23 (e.g., a second stem), and a lower stem 24 (e.g., a third stem) assembled relative to each other. In particular, the upper stem 22 is configured and dimensioned to at least partially receive a portion of the mid-stem 23, and the mid-stem 23 is configured and dimensioned to at least partially receive a portion of the lower stem 24.

In the assembled configuration, the needle assembly 16 defines a proximal end 36 and a distal end 38. The proximal end 36 defines the proximal end of the upper stem 22, while the distal end 38 defines the distal end of the lower stem 24. The proximal end 36 of the needle assembly 16 can be secured to a handle 32 in a non-rotatably manner (e.g., with a fastener, such as a screw 40), such that rotation of the handle 32 simultaneously rotates the upper stem 22 of the needle assembly 16.

The distal end 38 of the needle assembly 16 (i.e., the distal end of the lower stem 24) can be configured and dimensioned to at least partially be received in a passage 42 formed in the valve seat 14. The valve body 12 includes a first port 18 and a second port 20 formed therein and passing at least partially therethrough. The first and second ports 18, 20 can be formed on opposing sides of the valve body 12 and pass substantially parallel to each other a partial distance into the valve body 12. In some embodiments, the first and second ports 18, 20 can be offset from each other by a distance 44 measured along a central longitudinal axis A. In some embodiments, the first and second ports 18, 20 can both allow for bi-directional flow capability. Although shown as including first and second ports 18, 20, in some embodiments, any number of ports can be formed in the valve body 12, the ports being either inlet ports, outlet ports, or bi-directional ports. For example, the needle valve 10 can be a three-way valve, including three ports.

The passage 42 fluidically connects the first and second ports 18, 20 to each other. The passage 42 can extend substantially perpendicularly relative to the extension of the first and second ports 18, 20. Thus, a flow path for the fluid being controlled by the needle valve 10 can be formed between the two ports 18, 20 and passing through the passage 42 of the valve seat 14. Motion of the distal end 38 of the needle assembly 16 within the passage 42 along the central longitudinal axis A regulates opening and closing of the needle valve 10. In particular, actuating the needle assembly 16 to position the distal end 38 against the valve seat 14 blocks flow through the passage 42, thereby closing the needle valve 10. Conversely, actuating the needle assembly 16 to move the distal end 38 away from the valve seat 14 opens the passage 42, thereby opening the needle valve 10 and allowing flow to pass being the two ports 18, 20 through the passage 42.

As noted above, the needle assembly 16 includes the upper stem 22, the mid-stem 23, and the lower stem 24. As will be discussed in greater detail below, the assembly of the upper stem 22, the mid-stem 23 and the lower stem 24 can be such that the upper stem 22 is rotatably positioned relative to the valve body 12, while the mid-stem 23 and the lower stem 24 are in a non-rotating position relative to the valve body 12. The proximal end of the upper stem 22 (defined by the proximal end 36 of the needle assembly 16) includes a central bore 46 formed therein. The bore 46 includes internal threads 48 configured to mate with threads of the fastener 40 when the proximal end 36 is secured to the handle 32. The handle 32 includes an opening 50 formed therein configured and dimensioned to receive at least a portion of the proximal end 36 of the needle assembly 16.

The distal end 52 of the upper stem 22 includes a central bore 54 extending a partial distance from the distal end 52 to the proximal end 36 (e.g., one-third of the length of the upper stem 22, half of the length of the upper stem 22, or the like). The upper stem 22 includes external threads 56 on an outer surface of the upper stem 22 extending from the distal end 52. In some embodiments, the external threads 56 can cover a length of the outer surface corresponding to the depth of the bore 54. In some embodiments, the external threads 56 can cover a length of the outer surface smaller than the depth of the bore 54. The upper stem 22 includes internal threads 58 formed within the bore 54 and extending from the distal end 52 towards the proximal end 36. In some embodiments, the internal threads 58 can cover an entire length corresponding to a depth of the bore 54. In some embodiments, the internal threads 58 can cover a length corresponding to only a portion of the depth of the bore 54.

The mid-stem 23 includes a proximal end 60 and a distal end 62. The proximal end 60 includes external threads 64 on an outer surface of the mid-stem 23. The external threads 64 of the mid-stem 23 can be complementary to the internal threads 58 of the upper stem 22, such that the external threads 64 and the internal threads 58 can mate to allow the upper stem 22 to rotate relative to the mid-stem 23. Thus, the proximal end 60 of the mid-stem 23 can be threaded into the bore 54 at the distal end 52 of the upper stem 22. The distal end 62 of the mid-stem 23 includes a central opening or recess 66 formed therein. The opening 66 can include a first portion 68 at the distal end 62 defining a first diameter and includes a second portion 70 spaced from the distal end 62 and adjacent to the first portion 68 defining a second diameter. The first diameter of the first portion 68 can be dimensioned smaller than the second diameter of the second portion 70 such that an internal step or edge 72 is formed in the opening 66.

The lower stem 24 includes a proximal end 74 and a distal end (defined by the distal end 38 of the needle assembly 16). The proximal end 74 of the lower stem 24 includes a narrowed first portion 76 spaced from and adjacent to a second portion 78 and the proximal end 74. The first portion 76 defines a diameter dimensioned smaller than the diameter defined by the second portion 78. The configuration of the proximal end 74 can be complementary to the configuration of the opening 66 formed in the distal end 62 of the mid-stem 23. In particular, the difference in diameters of the proximal end 74 of the lower stem 24 and the opening 66 of the mid-stem 23 allows the proximal end 74 of the lower stem 24 to be inserted into and interlocked with the opening 66 (e.g., the edge 72) of the mid-stem 23. In some embodiments, rather than a difference in diameters, a fastener can be used to interlock the mid-stem 23 and the lower stem 24.

A stem seat 30 can be attached to or formed at the distal end 38 of the lower stem 24. In some embodiments, the stem seat 30 can be fabricated from a resilient material that creates a fluid tight seal when the stem seat 30 is positioned against the valve seat 14, thereby closing the passage 42. Thus, during assembly, the mid-stem 23 is threaded into the distal end 52 of the upper stem 22, and the proximal end 74 of the lower stem 24 is secured within the opening 66 at the distal end 62 of the mid-stem 23. Therefore, upon rotation of the handle 32, the upper stem 22, the mid-stem 23 and the lower stem 24 move conjointly.

The needle valve 10 includes a packing gland assembly 34 disposed to at least partially surround components of the needle assembly 16 to prevent leakage of the fluid from the valve body 12. In some embodiments, the packing gland assembly 34 is configured to completely encase the mid-stem 23, and only partially encase the upper stem 22 and/or the lower stem 24. The packing gland assembly 34 includes a packing gland body 80. The packing gland body 80 includes a central opening 82 configured to receive at least a portion of the needle assembly 16. The opening 82 includes internal threads 84 along at least a portion of the inner surface of the opening 82. The internal threads 84 are complementary to the external threads 56 of the upper stem 22. The distal end 52 of the upper stem 22 can therefore be threaded into the opening 82 of the packing gland body 80.

An 0-ring 86 maintains a fluid tight seal between the upper stem 22 and the opening 82 of the packing gland body 80 at the point where the upper stem 22 extends from the packing gland body 80. The packing gland body 80 includes external threads 88 at the distal end 90 of the packing gland body 80. The valve body 12 includes a bore 92 formed therein and extending perpendicularly to the ports 18, 20. The bore 92 includes internal threads 94 complementary to the external threads 88 of the packing gland body 80, such that a portion of the packing gland body 80 can be threaded into the bore 92.

The packing gland assembly 34 includes a top packing washer 25 (e.g., defining a T-shaped cross-section), one or more packing rings 26, and a bottom packing washer 28. The top packing washer 25, the one or more packing rings 26, and the bottom packing washer 28 can be received within a valve packing bore 15 formed in the valve body 12. In particular, the valve packing bore 15 connects the bore 92 of the valve body 12 with the passage 42, with an inner step formed between the valve packing bore 15 and the bore 92. In the assembled configuration, the top packing washer 25, the one or more packing rings 26 and the bottom packing washer 28 are positioned around a portion of the lower stem 24 and secure the lower stem 24 within the valve packing bore 15.

Although the lower stem 24 can travel along the central longitudinal axis A through the top packing washer 25, the one or more packing rings 26 and the bottom packing washer 28, the top packing washer 25, the one or more packing rings 26 and the bottom packing washer 28 maintain a fluid tight seal between the passage 42, the valve packing bore 15 and the needle assembly 16. Thus, rather than rotating within the valve body 12, the lower stem 24 travels along the central longitudinal axis A when the needle valve 10 is actuated to open or close.

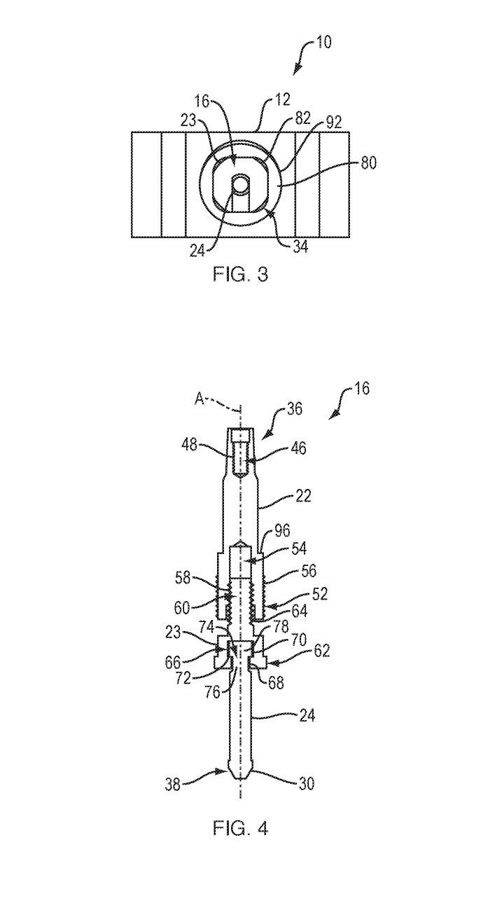

As shown in FIG. 3, the mid-stem 23 can be keyed to the opening 82 of the packing gland body 80. For example, the opening 82 of the packing gland body 80 can define a substantially square configuration with rounded corners. Similarly, the mid-stem 23 can define a substantially square configuration with rounded corners. The keyed configuration allows the mid-stem 23 to travel along the central longitudinal axis A through the opening 82 without allowing for rotation of the mid-stem 23 within the valve body 12 and the packing gland body 80. Although shown as substantially square with rounded corners, it should be understood that a variety of keyed configurations can be used. The packing gland assembly 34 can be prevented from rotating within the valve body 12 by various physical means, e.g., a keyed configuration relative to the bore 92 of the valve body 12, or the like.

In some embodiments, the threads on the packing gland assembly 34, the upper stem 22, the mid-stem 23 and the valve body 12 can be left-hand threads. If the handle 32 is rotated in the clockwise direction, the external threads 56 of the upper stem 22 interact or engage with the internal threads 84 in the packing gland body 80. The result is that the upper stem 22 rotates causing the upper stem 22 to move downwardly along the center longitudinal axis A towards the valve body 12 and the passage 42. The mid-stem, which is prevented from rotating by the packing gland body 80, simultaneously travels with the upper stem 22 along the central longitudinal axis A toward the passage 42.

In addition, as the upper stem 22 rotates, the external threads 64 of the mid-stem 23 interact or engage with the internal threads 58 of the upper stem 22 as the upper stem 22 rotates. The result is that the mid-stem 23 not only travels along with the upper stem 22, but also travels further away from the upper stem 22 and in the direction of the passage 42 with every rotation of the upper stem 22. In particular, clockwise rotation of the handle 32 results in the upper stem 22 rotating in the direction of an unscrewed position relative to the packing gland body 80. At the same time, clockwise rotation of the upper stem 22 results in the mid-stem 23 unscrewing from the upper stem 22.

As a result, the lower stem 24 travels along the central longitudinal axis A in the direction of the valve seat 30 a distance equal to the combined thread pitches of the external threads 56 and the internal threads 58 of the upper stem 22. Thus, rather than traveling a distance equal to only a single thread pitch (as generally occurs with traditional needle valves), actuation of the exemplary needle valve 10 results in the lower stem 24 traveling a distance equal to a dual set of thread pitches (e.g., a dual thread set mechanism). Continued clockwise rotation of the handle 32 results in a decrease in the orifice area of the passage 42 until the needle valve 10 is closed, i.e., the lower stem seat 30 comes into contact with the valve seat 14 to create a fluid tight seal of the passage 42 between the ports 18, 20.

If the handle is rotated in a counter-clockwise direction, the external threads 56 of the upper stem 22 interact or engage with the internal threads 84 of the packing gland body 80. The result is that the upper stem 22 rotates causing the upper stem 22 to move upwards and away from the valve body 12 and the passage 42. The mid-stem 23, which is prevented from rotating by the packing gland body 80, travels with the upper stem 22 along the central longitudinal axis A. In addition, the external threads 64 of the mid-stem 23 interact or engage with the internal threads 58 of the upper stem 22. The result is that the mid-stem not only travels along with the upper stem 22, but also travels closer to the upper stem 22 and away from the passage 42 with each rotation of the upper stem 22. In particular, counter-clockwise rotation of the handle 32 results in the upper stem 22 being screwed further into the packing gland body 80. At the same time, counter-clockwise rotation of the upper stem 22 results in the mid-stem 23 screwing further into the upper stem 22.

As a result, the lower stem 24 travels along the central longitudinal axis A in a direction away from the passage 42 a distance equal to the combined thread pitches of the external threads 56 and the internal threads 58 of the upper stem 22. Thus, rather than traveling a distance equal to only a single thread pitch (as generally occurs with traditional needle valves), actuation of the exemplary needle valve 10 results in the lower stem 24 traveling a distance equal to a dual set of thread pitches (e.g., a dual thread set mechanism). Continued counter-clockwise rotation of the handle 32 results in an increase in the orifice area of the passage 42 until the needle valve 10 is fully open, e.g., an edge 96 on an outer surface of the upper stem 22 comes into contact with an inner edge 98 within the opening 82 of the packing gland body 80. Interaction or engagement between the edge 96 of the upper stem 22 and the edge 98 of the packing gland body 80 can act as a stop corresponding to the fully open configuration of the needle valve 10.

The exemplary needle valve therefore provides a faster opening or closing time, allowing faster operation of the needle valve. In particular, interaction or engagement of the dual set of threads working in opposition allows the valve stem to travel a distance equal to the combined thread pitches, advantageously allowing for a faster and more efficient operation of the needle valve. The needle valve can be used in a variety of applications, such as offshore oil and gas, water jet cutting, general plant service, instrument isolation, hydraulic applications, pneumatic applications, pressure measurement devices, venting, or the like. The working pressure can be set at a variety of ranges, e.g., approximately 5,000 PSI to approximately 150,000 PSI, or the like.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A needle valve, comprising:
a valve seat;
a first stem in threaded engagement with a first stem thread; and
a second stem in threaded engagement with a second stem thread;
wherein rotation of the first stem advances the first stem and the second stem towards the valve seat by a distance that is equal to a combined thread pitch of the first stem thread and the second stem thread.

2. The needle valve of claim 1, wherein the first stem thread comprises a first set of external threads on an outer surface of the first stem, and the second stem thread comprises a first set of internal threads within a first stem bore of the first stem, and the second stem comprises a second set of external threads in threaded engagement with the first set of internal threads of the first stem.

3. The needle valve of claim 2, comprising a packing gland body including a second set of internal threads, the first set of external threads of the first stem being in threaded engagement with the second set of internal threads of the packing gland body.

4. The needle valve of claim 2, wherein rotation of the first stem advances the first stem a first distance towards the valve seat, the first distance corresponding to a thread pitch of the first set of external threads of the first stem, and rotation of the first stem advances the second stem a second distance towards the valve seat, the second distance corresponding to a combination of the thread pitch of the first set of external threads of the first stem and a thread pitch of the second set of external threads of the second stem.

5. The needle valve of claim 3, wherein engagement of the first set of external threads of the first stem with the second set of internal threads of the packing gland body is simultaneous to interaction of the first set of internal threads of the first stem with the second set of external threads of the second stem.

6. The needle valve of claim 1, wherein a distal end of the second stem includes a second stem opening formed therein.

7. The needle valve of claim 6, wherein the second stem opening comprises a first portion defining a first diameter and a second portion defining a second diameter, the first diameter being dimensioned smaller than the second diameter.

8. The needle valve of claim 6, comprising a third stem interlocked with the second stem opening at the distal end of the second stem.

9. The needle valve of claim 8, wherein the third stem includes a proximal end and a distal end, the distal end of the third stem forming a stem seat.

10. The needle valve of claim 9, wherein the proximal end of the third stem comprises a first portion defining a first diameter and a second portion defining a second diameter, the first diameter being dimensioned smaller than the second diameter.

11. The needle valve of claim 1, wherein the first stem rotates relative to the valve seat.

12. The needle valve of claim 3, wherein the packing gland body is keyed to the second stem to prevent rotation of the second stem relative to the valve seat during rotation of the first stem.

13. The needle valve of claim 8, wherein during rotation of the first stem, the third stem moves relative to the valve seat with the second stem without rotating.

14. The needle valve of claim 1, comprising a handle secured to a proximal end of the first stem and configured to actuate rotation of the first stem to open or close the needle valve.

15. The needle valve of claim 3, comprising a top packing washer, one or more packing rings, and a bottom packing washer disposed within the packing gland body.

16. A needle valve, comprising:
a valve body including a first port, a second port, and a passage formed in a valve seat fluidically connecting the first and second ports;
a needle assembly at least partially disposed within the valve body, the needle assembly including (i) a proximal end and a distal end, the distal end of the needle assembly being configured to mate with the valve seat to selectively close the passage, (ii) an upper stem including an upper stem bore formed therein, the upper stem including a first set of external threads on an outer surface of the upper stem and a first set of internal threads within the upper stem bore, and (iii) a mid-stem including a second set of external threads on an outer surface of the mid-stem, the second set of external threads being complementary to the first set of internal threads of the upper stem; and
a packing gland assembly disposed around at least a portion of the needle assembly, the packing gland assembly including a packing gland body with a second set of internal threads within a packing gland body bore, the second set of internal threads being complementary to the first set of external threads of the upper stem;
wherein in response to actuation of the needle assembly to close the passage in the valve seat, the first set of external threads of the upper stem interact with the second set of internal threads of the packing gland body to move the upper stem in the direction of the valve seat, and the first set of internal threads of the upper stem interact with the second set of external threads of the mid-stem to move the mid-stem in the direction of the valve seat.

17. The needle valve of claim 16, wherein a distance traveled by the upper stem along a central longitudinal axis of the needle assembly corresponds to a thread pitch of the first set of external threads of the upper stem, and a distance traveled by the mid-stem along the central longitudinal axis of the needle assembly corresponds to a combination of the thread pitch of the first set of external threads of the upper stem and the second set of external threads of the mid-stem.

18. The needle valve of claim 16, wherein a proximal end of the mid-stem includes the second set of external threads, and a distal end of the mid-stem includes a mid-stem opening formed therein.

19. The needle valve of claim 16, wherein the needle assembly comprises a lower stem interlocked with the mid-stem opening at the distal end of the mid-stem.

20. A method of operating a needle valve, comprising:
providing a needle valve, the needle valve including (i) a valve seat, (ii) a first stem in threaded engagement with a first stem thread, and (iii) a second stem in threaded engagement with a second stem thread; and
actuating rotation of the first stem to close the needle valve;
wherein rotation of the first stem advances the first stem and the second stem towards the valve seat by a distance that is equal to a combined thread pitch of the first stem thread and the second stem thread.
